(19) United States
(12) Patent Application Publication
(10) Pub. No.: US 2005/0166861 A1
(43) Pub. Date: Aug. 4, 2005

(54) DOUBLE DECKER PET STROLLER

(76) Inventor: Lise King, Port Washington, NY (US)

Correspondence Address: WILLIAM COLLARD;COLLARD & ROE, P.C., 1077 NORTHERN BOULEVARD, ROSLYN, NY, 11576, US

(21) Appl. No.: 10/907,946

(22) Filed: Apr. 21, 2005

Related U.S. Application Data
(63) Continuation-in-part of application No. 10/825,272, filed on Apr. 15, 2004.
Application No. 10/825,272 is a continuation of application No. 10/663,465, filed on Sep. 16, 2003, now abandoned.
(60) Provisional application No. 60/411,366, filed on Sep. 17, 2002.

(51) Int. Cl. A01K 1/03

(52) U.S. Cl. 119/496

(57) ABSTRACT

A pet stroller which includes a frame and at least one enclosure. There can also be an additional enclosure disposed on top of the first enclosure. The enclosures can include a hoop frame and a webbed netting which covers the frame. The enclosures can be opened by a door which can be used to allow animals or pets to be put inside.

### CROSS REFERENCE TO RELATED APPLICATIONS

This application is a continuation in part of U.S. patent application Ser. No. 10/825,272 filed on Apr. 15, 2004 which is a continuation in part application of U.S. patent application Ser. No. 10/663,465 filed on Sep. 16, 2003 which hereby claims priority from and the benefit of U.S. Provisional Application No. 60/411,366 filed on Sep. 17, 2002 wherein the disclosures of both listed utility applications and the provisional application are hereby incorporated herein by reference.

### BACKGROUND OF THE INVENTION

1. Field of the Invention

The present invention relates to an animal enclosure for use with a stroller wherein this device can be used for transporting small animals. This type of device includes at least two enclosures, which can be attached to a collapsible frame with wheels for transporting the pet.

### SUMMARY OF THE INVENTION

The invention relates to an animal enclosure in the form of an animal stroller that can be used to transport animals in a top and bottom manner. There can therefore be two animal enclosures for two different pets.

For example, there can be a pet stroller comprising a frame and at least two enclosures. The frame can comprise a plurality of wheels rotatably secured to a frame. The enclosure can include a frame and a flexible netting material secured to the frame and covering the outer section of the enclosure. There can also be a padded material covering the bottom section of the enclosure. However, in one embodiment there can be doors on both ends of the stroller.

There is also at least one door releasably secured to at least one of the end sections of the enclosure.

There can also be at least one additional enclosure coupled to the first enclosure. The additional enclosure can include additional netting covering the additional enclosure.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of the first embodiment of the invention;

FIG. 2 is a side view of another embodiment of the invention;

FIG. 3 is a side view of the container;

FIG. 4 is a side perspective view of one embodiment of the invention; and

FIG. 5 is a front perspective view of another embodiment of the invention.

### DETAILED DESCRIPTION

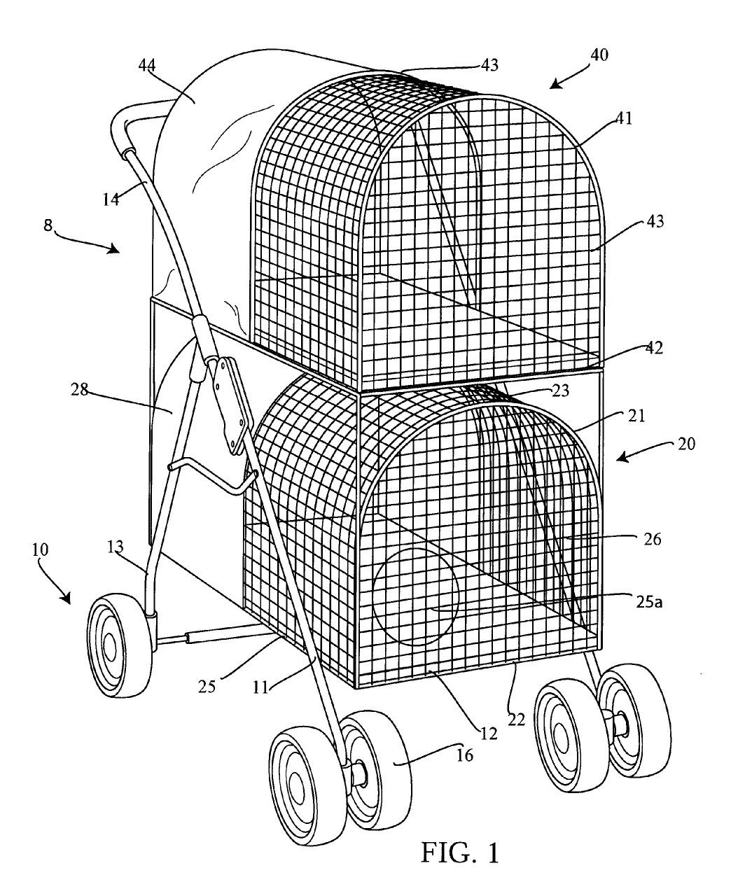

Turning now in detail to the drawings, FIG. 1 shows a perspective view of the device 8 which can include a first container 20 and a second container 40 disposed on frame 10 wherein this first container 20 includes a wire or metal rim in the form of a hoop 21, a base 22, a mesh screen 23, a divider 26 and a covering 28. Container 20 can include a bottom 25 which is made from heavy fabric and which can include a pillow or padded material, such that for example, one embodiment can include a padded base. For example, a pillow 25a or soft fabric cover may be placed on fabric bottom 25, or fabric bottom 25 may include a padding disposed therein. There is also a handle 29 (See FIG. 3) which can be in the form of a front and back handle extending lengthwise, which can be used to carry container 20. In this case, second container 40 can also include similar elements such as a hoop 41, a base 42, a mesh screen 43, a divider 46, and a covering 48.

As shown in FIG. 3, there is a door 27 mounted onto each end of enclosure 20 to let the animal in and out of enclosure 20. Door 27 can be made of one of the frame components or hoops 21 covered in netting or mesh screen 23. Door 27 is secured to enclosure 20 via string, a zipper a clasp, or any other known fastener. Door 27 opens downward so that the pet can easily exit the enclosure. Other securing devices could also be used.

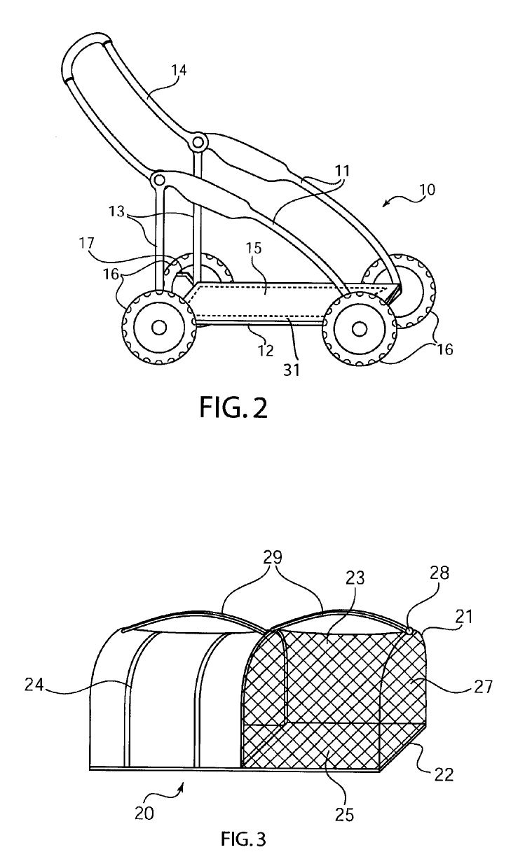

FIG. 2 shows a side perspective view of the frame. In this view, there is a bottom section 12 which can include a support or tray 15. Frame 10 can include side rails 11 and rear rails 13, which are connected to a handle 14. There are four wheels 16 rotatably mounted to frame 10 to allow frame 10 to roll along a surface. Wheels 16 are preferably rubber. Frame 10 is preferably made of metal tubing but other materials could be used. There is also a foot brake 17 which can be coupled to frame 10. Handle 14 can be mounted on a frame via a rotatable hinge 14a.

As shown in FIGS. 1-4, enclosure 20 can be mounted in frame 10 by placing enclosure 20 on tray 15. Tray 15 is made of stiff and durable material and is made to hold the weight of enclosure 20 and a small animal. Tray 15 can also be made from cloth stretched across two side rails 31 extending front to back from the front wheels to the back wheels. Side rails 11 prevent enclosure 20 from falling off of frame 10 during use. During use, the animal can sit comfortably either out in the open air or inside the tent formed from cover 24. The stroller according to the invention could be made in many different sizes.

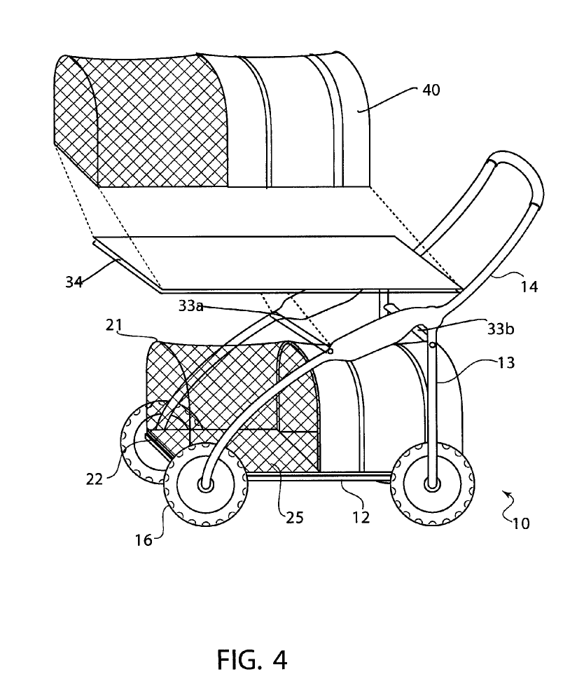

In one embodiment of the double decker stroller as shown in FIG. 4, there is an additional tray 34 which can be mounted on guide rails 33a and 33b extending across side rails 11. Guide rails 33a and 33b support additional tray 34 in place, wherein tray 34 can be mounted on guide rails 33a and 33b in any known manner such as with any known fasteners which may include screws, bolts, nuts, adhesives, brackets, cloth wrap etc. This is so that the stroller can be used as a portable grooming station.

The second container 40 can also be selectively secured to additional tray 34 wherein second container 40 can be mounted directly on additional tray 34 and then fastened thereto by any known fastening means such as brackets, cloth, bolts screws, clips etc.

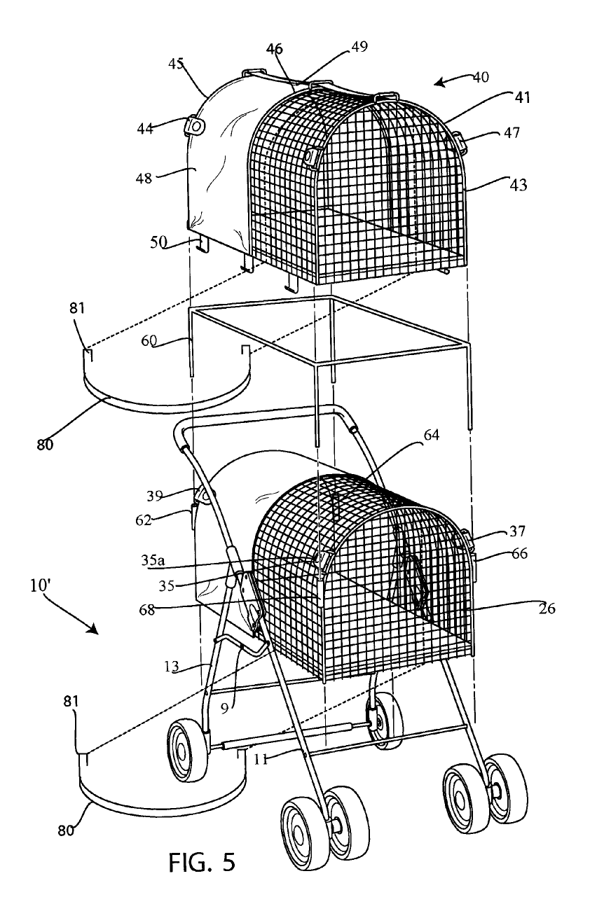

FIG. 5 shows an alternative embodiment of the invention which can include a first container 20 disposed on tray 15 and a frame 10′, wherein this frame 10′ includes side bars 11 and 13 and a collapsible connecting bar 9 which allows side bars 13 and 11 to collapse onto themselves. This frame 10′ does not include the trays shown in FIG. 4. There is also an additional frame 60 coupled to first container 20 via a plurality of connecting elements 62, 64, 66, 68 which can be used to receive frame or supporting bracket 60. These connecting elements 62, 64, 66, 68 can be in the form of cylinders, which receive supporting bracket 60. These connecting elements can be coupled to the frame of first container 20 by any known means such as welding, clamping, screws associated with a bracket or any other known fasteners.

In addition, as shown in this view, coupled to door 27 is a door securing and closing means 35, and 37 in the form of a loop which can be in the form of a cloth or leather strap which can have a fastening closure 35a in the form of a snap enclosure, a hook and loop fastener, a turnable clasp or any other type of fastening means. There is also a back end fastener 39 which can be snapped closed on a back end.

Top or additional container 40 can be secured to bracket or frame 60 via a plurality of clips 50 which can be used to secure additional container 40 to bracket 60. Alternatively, additional container 40 can be secured to the lower container 20 via any known means. One means or method would be to use a bungee cord or strap 80 with clips 81 to secure either one or both enclosures to the frames. The bungee cord 80 has clips 81 that would secure to the enclosure and then wrap around underneath any securing means such as the tray and then secure to the opposite side of the enclosure with the opposite clip. This type of securing device would then keep one or more of the enclosures releasably secured with the frame. Additional container 40 also includes semi-circular hoops 41, 46, and 45. In addition, additional container 40 includes a back end fastener 44 and a front end fastener 47, along with additional straps 49, wherein additional straps 49 can be used to carry container 40.

The device is designed to be made in many different sizes and from many different materials. Essentially it is designed as a portable and collapsible device, which can include two enclosures coupled to a frame.

Accordingly, while a few embodiments of the present invention have been shown and described, it is to be understood that many changes and modifications may be made thereunto without departing from the spirit and scope of the invention as defined in the appended claims.

1. A pet stroller comprising:
a) a frame comprising;
i) a bottom section,
ii) a handle disposed on said frame,
iii) a plurality of wheels rotatably secured to said frame; and
b) an enclosure comprising;
i) an enclosure frame forming a bottom section of said enclosure, an outer section of said enclosure, and a plurality of end sections of said enclosure, said enclosure frame comprising a plurality of semicircular hoop portions and a plurality of crossbars;
ii) a flexible netting material secured to said enclosure frame and covering said outer section of said enclosure;
iii) a padded material covering the bottom section of said enclosure;
iv) at least one door releasably secured to at least one of said plurality of end sections of said enclosure;
v) a handle mounted to said enclosure for carrying said enclosure; and
c) at least one additional enclosure coupled to said enclosure, wherein said at least additional enclosure includes additional netting covering said at least one additional enclosure;
wherein said enclosure is mounted in said frame by placing said enclosure on said tray.

2. The pet stroller according to claim 1, wherein said frame comprises a plurality of side rails secured to said bottom section and a plurality of rear rails secured to said bottom section.

3. The pet stroller according to claim 2, wherein said plurality of side rails and said plurality of rear rails are comprised of metal tubing.

4. The pet stroller according to claim 1, wherein said frame is collapsible.

5. The pet stroller according to claim 1, wherein said flexible material is secured to said enclosure frame with adhesive, rivets or binding.

6. The pet stroller according to claim 1, wherein said
netting material comprises a mesh material.

7. The pet stroller according to claim 1, wherein
said netting material is secured to said enclosure frame by rope or string which is wrapped through a hole in said netting material and around said enclosure frame.

8. The pet stroller according to claim 1, further
comprising a durable, water resistant material disposed on a portion of said outer section of said enclosure.

9. The pet stroller according to claim 1, wherein the durable water resistant material covers one of the end section of the enclosure.

10. The pet enclosure according to claim 9, further comprising a window cut in the end section that contains the water resistant material.

11. The pet enclosure according to claim 9, further comprising a pocket located in said end section containing the water resistant material.

12. The pet stroller according to claim 8, wherein said durable water-resistant material disposed on a portion of said outer section of said enclosure covers approximately one half of the length of said enclosure.

13. The pet stroller according to claim 1, wherein said
enclosure is collapsible.

14. The pet stroller according to claim 1, wherein each
of said plurality of wheels is comprised of rubber.

15. The pet stroller according to claim 1, wherein said wheels are removable.

16. The pet stroller according to claim 1, wherein said
plurality of wheels comprises six wheels.

17. The pet enclosure according to claim 1, further comprising a brake to stop rotation of said plurality of wheels.

18. The pet stroller according to claim 1, wherein said
enclosure frame is constructed from a strong weather-proof material selected from the group consisting of aluminum, steel and heavy plastic.

19. The pet stroller according to claim 1, wherein said
door is releasably secured to at least one of said plurality of end sections of said enclosure by a clasp.

20. A pet stroller comprising:
a) a frame comprising a plurality of wheels rotatably secured to said frame; and
b) an enclosure comprising;
i) an enclosure frame;
ii) a flexible netting material secured to said enclosure frame and covering said outer section of said enclosure;
iv) at least one door releasably secured to at least one of said plurality of end sections of said enclosure; and
c) at least one additional enclosure coupled to said enclosure, wherein said at least additional enclosure includes at least one frame and additional netting covering said at least one frame of said at least one additional enclosure.
